(19) United States
(12) Patent Application Publication
(10) Pub. No.: US 2024/0005207 A1
(43) Pub. Date: Jan. 4, 2024

(54) METHOD FOR TRAINING AT LEAST ONE ARTIFICIAL INTELLIGENCE MODEL FOR ESTIMATING THE WEIGHT OF AN AIRCRAFT DURING FLIGHT BASED ON USE DATA

(71) Applicant: AIRBUS HELICOPTERS, Marignane Cedex (FR)

(72) Inventors: Ammar MECHOUCHE, Aix-En-Provence (FR); Antonin ROCHER, Sausset-Les-Pins (FR); Valentin AUBIN, Istres (FR)

(73) Assignee: AIRBUS HELICOPTERS, Marignane Cedex (FR)

(21) Appl. No.: 18/209,183

(22) Filed: Jun. 13, 2023

(30) Foreign Application Priority Data
Jul. 1, 2022 (FR) 2206717

(51) Int. Cl. G06N 20/00; B64D 45/00; G01G 19/414; G01G 19/07

(52) U.S. Cl. CPC G06N 20/00; B64D 45/00; G01G 19/414; G01G 19/07

(57) ABSTRACT

A method for training at least one artificial intelligence model for estimating the weight of an aircraft during flight based on use data, the at least one artificial intelligence model being developed in order to be implemented during at least one predetermined flight phase of at least one aircraft of the same type. The method comprises carrying out a plurality of flights and, for at least one of the plurality of flights, the method comprises acquiring, during flight, at least one set of flight data, carrying out at least one consistency test in order to check that a reliable reference weight is calculated or capable of being calculated, calculating at least one calculated weight of the aircraft and storing the at least one set of flight data and the at least one calculated weight.

### CROSS-REFERENCE TO RELATED APPLICATIONS

This application claims priority to French patent application No. FR 22 06717 filed on Jul. 1, 2022, the disclosure of which is incorporated in its entirety by reference herein.

### TECHNICAL FIELD

The present disclosure relates to a method for training at least one machine learning artificial intelligence model. The disclosure lies in the field of methods for estimating the weight of an aircraft at any time during a flight and on the ground.

### BACKGROUND

Accurately estimating the weight of the aircraft may affect the prediction of the performance of the aircraft during flight, and also the predictive maintenance of the aircraft.

According to one known method, the payload of an aircraft is input by the crew or estimated based on information input by the crew such as the number of passengers on board and using a standard weight for each of the passengers. As a result, the total weight of the aircraft is not known, and the payload cannot be calculated or input with sufficient accuracy. Moreover, the updating of the payload by the crew may be subject to oversight.

According to another method described, for example, in document EP 3 940 360, the weight of an aircraft and the position of a center of mass of the aircraft are estimated using pressure sensors arranged at landing gears. However, not all aircraft are equipped with instrumented landing gears allowing these estimations to be made. Moreover, such an estimation can only be made on the ground.

According to another method, flight data of an aircraft and a machine learning artificial intelligence model using that flight data are implemented in order to estimate the weight of the aircraft.

The quality of such a method depends in particular on the training of the model. The disclosure therefore relates more specifically to a method for training at least one machine learning artificial intelligence model for estimating the weight of an aircraft during flight based on use data.

Document U.S. Pat. No. 5,987,397A discloses a method for estimating the weight of an aircraft with a model consisting in correlating the flight parameters and the weight recorded by the aircraft during dedicated flight tests.

Document FR 3 036 789 discloses estimating the weight of an aircraft by means of performance parameters and document EP 1 462 897 proposes estimating the weight of an aircraft by using neural network models chosen according to a flight phase.

The training data for these machine learning artificial intelligence models are obtained by means of flight tests. The quantity and representativity of this training data for the models may be limited.

Document FR 3 103 047A1 describes a neural network learning method for helping to land an airplane on a landing strip, in particular during difficult weather conditions.

The method comprises at least steps of:
receiving a set of labelled training data comprising sensor data associated with ground data representing at least a landing strip and an approach ramp;
running an artificial neural network deep learning algorithm on the set of training data, said deep learning algorithm using a cost function referred to as a landing strip threshold trapeze, parameterized to recognize a landing strip and approach ramp threshold; and
generating an artificial intelligence model trained to help land aircraft that can recognize landing strips.

Therefore, document FR 3 103 047A1 describes acquiring, during flight, at least one set of flight data acquired with several sensing devices at a given point in time t.

Document FR 2 988 851A1 describes a method for determining a credibility status of measurements of an angle-of-attack sensor of an aircraft that comprises at least one consistency test (90, 100) for testing the consistency between angle-of-attack measurements of said sensor, and measurements of a flight characteristic of the aircraft, different from the angle of attack.

Such a method comprises the following steps:
determining the value of the angle of attack, using said sensor;
determining said flight characteristic;
determining (94, 106) a value of an indicator of the consistency of the angle-of-attack value with said characteristic; and
activating a low credibility status (76), wherein the measurements of said angle-of-attack sensor are judged to be unreliable, or an intermediate credibility status (107), wherein the measurements of said angle-of-attack sensor are judged to be consistent with said flight characteristic, as a function of the value of said consistency indicator.

### SUMMARY

An object of the present disclosure is thus to propose a method for training at least one machine learning artificial intelligence model that helps overcome the above-mentioned limitations. Such a training method helps to construct robust models suitable for real missions of a user of the aircraft in order to estimate the weight of the aircraft, at any point in time, during flight or on the ground.

The disclosure therefore relates to a method for training at least one machine learning artificial intelligence model, said at least one machine learning artificial intelligence model being configured to be stored in a memory equipping an aircraft or a ground station, and developed in order to be implemented during at least one predetermined flight phase of at least one aircraft of the same type.

Such a method comprises a plurality of flights being carried out by at least one user or client of the one or more aircraft. Therefore, for at least one of the plurality of flights, the method comprises acquiring, during flight, at least one set of flight data acquired with several sensing devices at the same point in time t.

According to the disclosure, such a method is remarkable wherein, for said at least one of the plurality of flights, the method comprises the following steps:
carrying out at least one predetermined consistency test with at least one consistency controller, said at least one consistency test making it possible to check that a reliable reference weight is calculated or capable of being calculated;
calculating, with at least one weight calculation controller, at least one calculated weight of the aircraft as a function of at least one weight chosen from the group comprising a current boarded fuel weight, a consumed fuel weight, a previously measured weight of said aircraft, an empty weight of said aircraft, a payload previously input by a user, a weight measured by a piece of connected equipment, and said reference weight; and
if said at least one consistency test is validated, storing said at least one set of flight data and said at least one weight calculated at the point in time t, each stored set of flight data associated with a calculated weight forming a set of training data for said at least one machine learning artificial intelligence model, and
wherein the method comprises using the sets of training data to program said at least one machine learning artificial intelligence model, said at least one machine learning artificial intelligence model being configured to estimate, at any time, an estimated instantaneous weight of the aircraft, or another aircraft of the same type, based on a current set of flight data.

In other words, depending on a result of the consistency test carried out prior to a mission of the aircraft, the acquired set or sets of flight data and the corresponding calculated weight or weights acquired at the same point in time t are kept, then used to program said at least one machine learning artificial intelligence model.

“Point in time t” should be understood to mean a precise period limited in time, for example of one or more seconds, or one or more minutes, allowing all of the flight data acquisitions to be made and the calculated weight to be calculated.

Furthermore, a mission performed by the aircraft that contains no flight phase suitable for calculating the aircraft weight will not be processed and will not provide any set of training data.

Moreover, the expression “check that a reliable reference weight is calculated or capable of being calculated” means that a check is made on the availability, existence or possible calculation of a reference weight. This reference weight is further considered to be the total weight of the aircraft comprising the weight of the crew and any possible passengers, the weight of the cargo or luggage that may be on board, the weight measured by a piece of connected equipment and the weight of the boarded fuel. This reference weight therefore corresponds to the total weight when the consistency test is carried out.

A consistency test may be considered as being validated during a flight or a session of several flights between the powering up of the consistency controller or controllers and the switching off of the consistency controller or controllers. Alternatively, a consistency test may also be validated for a predetermined period, for example 24 hours, or for a predetermined number of take-offs and landings.

The calculated weight corresponds to a change in the total weight of the aircraft after carrying out a consistency test, and therefore starting from the reference weight. This change in weight may depend in particular on an amount of fuel consumed or an amount of fuel added to a tank or indeed a modified payload. Such a calculated weight may be calculated at any point in time during the flight or indeed after a flight by using sets of flight data stored after the consistency test.

Furthermore, the consistency controller or controllers used to perform the consistency test and weight calculation controller or controllers may be separate from each other or indeed form a one-piece assembly.

For example, a first one-piece assembly suitable for carrying out both a consistency test and a calculation of the calculated weight may be arranged in the aircraft and a one-piece assembly suitable for carrying out a consistency test and a calculation of the calculated weight may be arranged outside the aircraft, for example in a ground station.

Several successive weights may then be calculated during a flight of the aircraft. However, a single calculated weight may correspond to the point in time t.

These sets of flight data are acquired by sensing devices that may be of different natures and suitable for identifying movement parameters of the aircraft or indeed physico-chemical parameters relating, for example, to the environment wherein the aircraft is travelling. Furthermore, each sensing device may comprise one or more sensors and possibly a computer for converting a physical, electromagnetic or optical measurement into another quantity, by means of at least one calculation.

“Sensing device” should be understood to mean a physical sensor capable of directly measuring the parameter in question but also a system that may comprise one or more physical sensors as well as means for processing the signal that make it possible to provide an estimation of the parameter based on the measurements provided by these physical sensors. Similarly, the expression “measuring the parameter” refers to both a raw measurement from a physical sensor and a measurement obtained by relatively complex processing of raw measurement signals.

Moreover, the reference weight may further be considered as being capable of being calculated under several independent or cumulative conditions.

For example, a reference weight may be considered as being capable of being calculated if the payload of the aircraft is input by a pilot before a mission or before a series of missions. Indeed, the reference weight may be calculated by adding an empty weight of the aircraft to the weight of boarded fuel and the payload comprising the weight of the crew, luggage, cargo, measured by a piece of connected equipment, and possible passengers.

Moreover, conditions on the input value of the payload may also help ensure the reliability of the reference weight that will be calculated. The reference weight may be considered to be reliable if the payload input by the pilot is different to a zero value, if it is greater than a first predetermined threshold or indeed if it is less than a second predetermined threshold.

Furthermore, such a training method can be used to construct and apply a machine learning artificial intelligence model for estimating the weight of an aircraft at any point in time based on large amounts of real flight data representative of the users or clients.

Such a method therefore allows possible erroneous or unsuitable flight data to be discarded so as not to interfere with the training of the machine learning model or models.

Moreover, such a method may be applicable to any type of aircraft, in particular a helicopter, without requiring the use of additional instrumentation.

The reference weight may further correspond to a weight calculated by an avionics system equipping the aircraft.

The method may further comprise one or more of the following features, taken individually or in combination.

In particular when it is being calculated, the reliability of the calculated reference weight may be determined in different ways.

According to a first embodiment of the disclosure, the reference weight may be defined as a function of an estimated weight of the aircraft based on measurements from several sensors, each sensor being arranged on each landing gear of the aircraft, said at least one consistency test comprising calculating a difference between said calculated weight and the estimated weight, and then checking that this difference is less than a difference threshold value.

The calculated weight stored in the avionics system of the aircraft is then compared with the estimated weight determined using signals from the sensors. As previously for the flight data, these sensors may be physical sensors capable of directly measuring the weight on each landing gear, but also a system that may comprise one or more physical sensors as well as means for processing the signal that make it possible to provide an estimation of the weight based on the measurements provided by these physical sensors.

These sensors may therefore be chosen from the group comprising force sensors, pressure sensors, displacement sensors, position sensors and deformation sensors.

The predetermined threshold value may be stored in a memory on board the aircraft and obtained by previous tests or flights by the aircraft or another aircraft of the same type. For example, the predetermined threshold value may correspond to a percentage of the weight estimated by the sensors.

In this case, the reference weight may be chosen from the previously calculated weight or the estimated weight or may be calculated at least depending on the estimated or calculated weight, for example by taking an average of the estimated weight and the calculated weight.

According to a second embodiment of the disclosure, the reference weight may be defined as a function of a checked theoretical weight of the aircraft, said at least one consistency test comprising checking the parameterization of the checked theoretical weight.

The checked theoretical weight is obtained by ensuring, before a flight of the aircraft, that the weight of the aircraft is correctly input in the avionics system.

The consistency test then consists in checking that the checked theoretical weight has been parameterized, for example by the pilot or a crew member.

For example, the checked theoretical weight may by default be chosen to be equal to a value of zero. The consistency test then consists in checking that this checked theoretical weight is strictly greater than 0.

In this case, the reference weight may be chosen to be equal to the checked theoretical weight or indeed may be calculated at least as a function of the checked theoretical weight, for example by applying a safety coefficient to the checked theoretical weight.

According to a third embodiment of the disclosure, the reference weight may be defined as a function of a calculated theoretical weight of the aircraft, the calculated theoretical weight being obtained by said at least one weight calculation controller based on at least one piece of information parameterized with a human-machine interface of the aircraft by the user prior to said at least one consistency test, said at least one consistency test comprising checking that said at least one piece of information has been parameterized.

Such a calculated theoretical weight of the aircraft may be obtained by calculating, prior to a flight of the aircraft, the weight of the aircraft as a function of an update of the payload input by the pilot.

The consistency test may therefore check an update of the payload carried out by the pilot before the flight by inputting or recording information.

In this case, the reference weight may be chosen to be equal to the calculated theoretical weight or indeed may be calculated at least as a function of the calculated theoretical weight, for example by applying a safety coefficient to the calculated theoretical weight.

Advantageously, the flight data may have data relating to at least two flight parameters chosen from the group comprising a speed of the aircraft in relation to the air, a vertical speed of the aircraft in relation to the ground, a longitudinal speed of the aircraft in relation to the ground, a lateral speed of the aircraft in relation to the ground, a vertical acceleration of the aircraft in relation to the ground, a flow of fuel supplying an engine of the aircraft, a rotational speed of a rotor equipping the aircraft, a wind direction, a wind speed, a quantity of fuel on board the aircraft, a yaw trajectory of the aircraft, the attitude of the aircraft, an air density, an air temperature, an angle of attack of a wing of the aircraft, an altitude of the aircraft, a power consumed by at least one engine of the aircraft, positions of flight controls and positions of blades of a rotor and/or of a propeller.

For each flight, the recording of the different sets of flight data may be broken down into different phases. Only those flight phases that optimize the calculation of the aircraft's calculated weight and that are present in a large proportion of the missions carried out by the user of the aircraft are retained from the broken-down flights as a whole.

Furthermore, the flight data of the sets of flight data may be supplied by equipment already provided on the aircraft such as, for example, a flight management system referred to by the acronym FMS, an air data computer referred to by the acronym ADC, an attitude and heading reference system referred to by the acronym AHRS, a radio altimeter Rad Alt and a global navigation satellite system referred to by the acronym GNSS.

The air data computer ADC may thus provide the pressure altitude and the speed of an aircraft.

The attitude and heading reference system AHRS may provide information on the attitude and heading, accelerations and rates of climb or descent of the aircraft.

With the input of the ADC, the AHRS provides the instantaneous vertical speed.

With the inputs of the GNSS and the FMS, the AHRS provides a combined navigation position and ground speed in each direction.

The radio altimeter Rad Alt provides the height of the aircraft above the overflown ground or water.

The flight management system FMS generally comprises a display and an interface device such as a control panel. The function of the FMS is to program waypoints and to coordinate the flight plans of the aircraft. The satellite positioning system GNSS is generally a subsystem of the FMS.

In practice, before using the sets of training data, the method may comprise a count for counting the number N of the sets of training data and a comparison between the number N and a predetermined threshold value S.

Therefore, as long as there are not enough sets of training data, the method stores them in a memory that may be on board the aircraft, or in a memory of a ground station, without using them. Such a predetermined threshold value S may therefore also be stored in a memory that may be on board the aircraft, or in a memory of a ground station, when the training method is implemented directly in the aircraft in question.

Alternatively, this predetermined threshold value S may also be stored in a memory outside the aircraft when the training method is implemented outside the aircraft in question.

Moreover, the sets of training data may be used by the training method when the number N is greater than or equal to the predetermined threshold value S.

The sets of training data are therefore used by the training method when the number N of sets of training data reaches the predetermined threshold value S. Such a predetermined threshold value S may for example be equal to 1000.

In practice, said at least one machine learning artificial intelligence model may comprise a first model and a second model different from the first model, the first model being associated with a first predetermined flight phase from said at least one predetermined flight phase and the second model being associated with a second predetermined flight phase from said at least one predetermined flight phase, the first predetermined flight phase being different from the second predetermined flight phase.

In other words, a machine learning artificial intelligence model may be associated with each identified type of predetermined flight phase. Consequently, the sets of training data may be associated with a particular model by identifying which type of predetermined flight phases they relate to.

During a flight carried out by the user, several weight calculations may be carried out and correspond to different points in time t.

Furthermore, the flight phases may be chosen in advance according to different criteria.

According to a first variant of the disclosure, said at least one predetermined flight phase may be chosen as a function of a required accuracy of said at least one machine learning artificial intelligence model for estimating, at any time, the estimated instantaneous weight of the aircraft, or an aircraft of the same type, based on a current set of flight data.

In other words, the predetermined flight phase or phases during which the sets of flight data are used make it possible to obtain the required accuracy of the machine learning artificial intelligence model during its subsequent use.

According to a second variant of the disclosure, said at least one predetermined flight phase may be chosen as a function of a required dispersion of said at least one machine learning artificial intelligence model for estimating, at any time, the estimated instantaneous weight of the aircraft, or an aircraft of the same type, based on a current set of flight data.

As previously for the required accuracy, the predetermined flight phase or phases during which the sets of flight data are used make it possible in this case to achieve the required dispersion of the machine learning artificial intelligence model during its subsequent use.

According to a third variant of the disclosure, said at least one predetermined flight phase may be chosen as a function of the diversity of the plurality of flights performed by the user of the aircraft, or an aircraft of the same type.

In this case, the predetermined flight phase or phases during which the sets of flight data are used make it possible in this case to provide a large number of sets of flight data. Indeed, when using the model or models, the predetermined flight phases will be covered in a prioritized way.

In practice, said at least one machine learning artificial intelligence model may be chosen from the group comprising decision tree algorithms, random forest algorithms, support vector machine algorithms, adaptive boosting algorithms, back-propagation algorithms, gradient boosting algorithms, neural network algorithms, and deep neural network algorithms.

Indeed, such types of machine learning artificial intelligence models are well suited to predicting the calculated weight of an aircraft as a function of the available sets of flight data provided by an existing avionics system.

### BRIEF DESCRIPTION OF THE DRAWINGS

The disclosure and its advantages appear in greater detail in the context of the following description of embodiments given by way of illustration and with reference to the accompanying figures, wherein:

FIG. 1 is a side view diagram of an aircraft suitable for implementing a training method according to the disclosure;

FIG. 2 is a logic diagram showing steps of a training method according to the disclosure;

FIG. 3 is a diagram of a step of using training data for programming a machine learning artificial intelligence model, according to the disclosure; and

FIG. 4 is a logic diagram representative of the steps performed in order to carry out at least one predetermined consistency test according to the disclosure.

### DETAILED DESCRIPTION

Elements that are present in more than one of the figures are given the same references in each of them.

As already mentioned, the disclosure relates to the field of estimating an estimated instantaneous weight of an aircraft at any point in time and, in particular, during the flight of an aircraft.

The disclosure more specifically relates to a method for training at least one machine learning artificial intelligence model configured to be stored in a memory equipping an aircraft or a ground station.

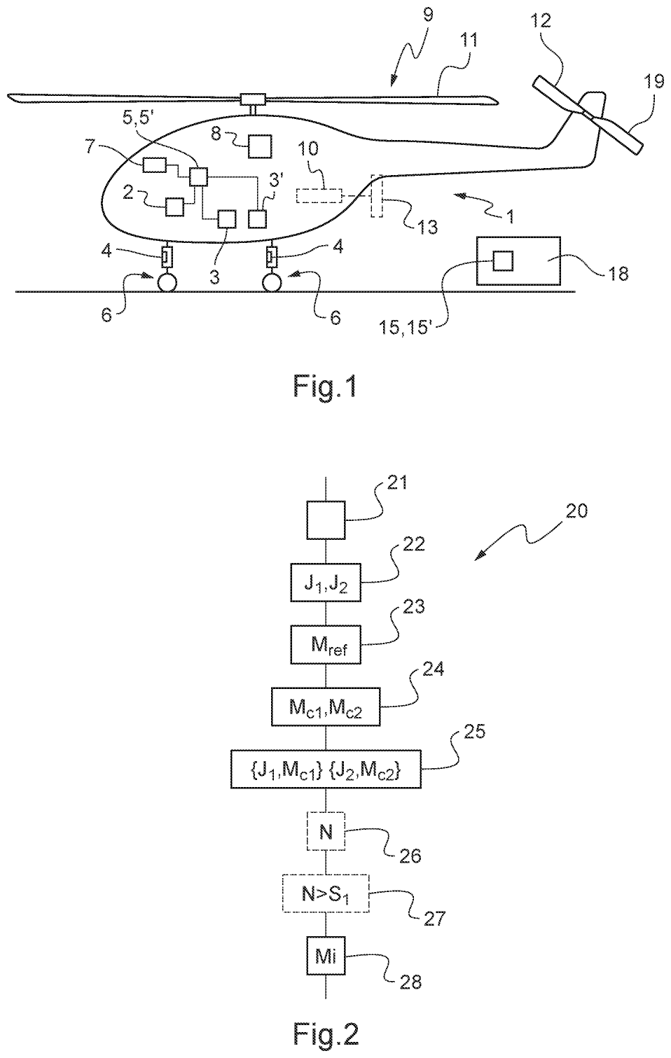

As shown in FIG. 1, an aircraft 1 such as a rotorcraft comprises a memory 2. Such a memory 2 is in particular designed to contain one or more machine learning artificial intelligence models developed to be implemented during at least one predetermined flight phase of one or several aircraft 1 of the same type.

Such machine learning artificial intelligence models will be described in greater detail in FIGS. 2 to 4.

Such an aircraft 1 therefore comprises several sensing devices 3, 3′ of different natures for acquiring different data at the same point in time t and forming at least one set of flight data J1, J2.

A set of flight data therefore comprises several items of flight data different from each other and acquired at the same point in time t, these data each being representative of a flight parameter.

For example, the flight data provided by the sensing devices 3, 3′ may have data relating to at least two flight parameters chosen from the group comprising a speed of the aircraft 1 in relation to the air, a vertical speed of the aircraft 1 in relation to the ground, a longitudinal speed of the aircraft 1 in relation to the ground, a lateral speed of the aircraft 1 in relation to the ground, a vertical acceleration of the aircraft 1 in relation to the ground, a flow of fuel supplying an engine 8, of the aircraft 1, a rotational speed of a rotor 9 equipping the aircraft 1, a wind direction, a wind speed, an angle of attack of the wing, a quantity of fuel on board the aircraft 1, a yaw trajectory of the aircraft 1, the attitude of the aircraft 1 defined by attitude angles around roll, pitch and yaw axes, an air density, an air temperature, an altitude of the aircraft 1, an angle of attack of a wing of the aircraft 1, a power consumed by at least one engine 8, 10 of the aircraft 1, positions of flight controls and positions of blades 11, 12 of a rotor 9, 19 and/or of a propeller 13.

Furthermore, the sensing devices 3, 3′ may be connected to an avionics system already provided on the aircraft 1 comprising, but not limited to, a flight management system FMS, an air data computer ADC, an attitude and heading reference system AHRS, a radio altimeter Rad Alt and a satellite positioning system GNSS.

Moreover, each sensing device 3, 3′ may comprise a physical sensor or several physical sensors and processing means.

These sensing devices 3, 3′ may be connected by wired or wireless means to at least one weight calculation controller 5′ equipping the aircraft 1 for processing and/or storing the sets of flight data J1, J2.

Alternatively, or additionally, the sensing devices 3, 3′ may also be connected by wired or wireless means to at least one weight calculation controller 15′ equipping a ground station 18 for processing and/or storing the sets of flight data J1, J2 outside the aircraft 1.

Moreover, the weight calculation controller or controllers 5′, 15′ may respectively comprise, for example, at least one processor and at least one memory, at least one integrated circuit, at least one programmable system, or at least one logic circuit, these examples not limiting the scope given to the expression “controller”. The term “processor” may refer equally to a central processing unit or CPU, a graphics processing unit or GPU, a digital signal processor or DSP, a microcontroller, etc.

Advantageously, such an aircraft 1 may comprise sensors 4 arranged on landing gears 6. These sensors 4 may also be connected by wired or wireless means to the weight calculation controller or controllers 5′, 15′ in order to estimate an estimated weight Me of the aircraft 1 and/or to at least one consistency controller 5, 15.

These sensors 4 may therefore be chosen from the group comprising force sensors, pressure sensors, displacement sensors, position sensors and deformation sensors.

Furthermore, the weight calculation controller or controllers 5′, 15′ and the consistency controller or controllers 5, 15 may be separate from each other or form a one-piece assembly, as shown in FIG. 1. However, the representation in FIG. 1 is only provided as a non-limiting example.

Moreover, such an aircraft 1 may comprise a human-machine interface 7 allowing the pilot of the aircraft 1, for example, to update a parameter linked to an item of information relating to a calculated theoretical weight Mtc of the aircraft 1. Furthermore, such a human-machine interface 7 is then connected by wired or wireless means to the consistency controller or controllers 5, 15.

As shown in FIG. 2, the method 20 comprises a plurality of flights being carried out 21 by a user of the aircraft 1 or by another user of another aircraft of the same type.

Therefore, for at least one of the plurality of flights, the method 20 comprises acquiring 22, during flight, at least one set of flight data J1, J2 acquired at the same point in time t with the sensing devices 3, 3′ described above.

The method 20 then comprises carrying out 23 at least one predetermined consistency test with the controller or controllers 5, 15. For example, and as shown in FIG. 4, three consistency tests may be implemented separately in parallel. This or these consistency tests can therefore be used to check that a reliable reference weight Mref has already been calculated and is therefore stored or indeed that it is capable of being calculated.

Furthermore, the method 20 comprises calculating 24, with the controller or controllers 5′, 15′, at least one calculated weight Mc of the aircraft 1 as a function of at least one weight chosen from the group comprising a current boarded fuel weight, a consumed fuel weight, a previously measured weight of the aircraft 1, an empty weight of said aircraft 1, a payload previously input by a user, a weight measured by a piece of connected equipment such as a winch or a sling, and said reference weight Mref.

Then, if one of the consistency tests is validated, the method 20 comprises storing 25 the set or sets of flight data J1, J2 acquired at the point in time t of the flight and said at least one calculated weight Mc1, Mc2 at the same point in time t.

The weight calculation controller or controllers 5′, 15′ make it possible to associate each set of flight data J1, J2 with a corresponding calculated weight Mc1, Mc2 in order to form a set of training data {J1, Mc1}, {J2, Mc2} for the machine learning artificial intelligence model or models that may be contained in the onboard memory 2.

Therefore, such a set of training data {J1, Mc1}, {J2, Mc2} results from at least one flight carried out by the user of the aircraft 1 in real conditions during a mission and not during a test phase carried out by the constructor of the aircraft 1.

Before using the sets of training data {J1, Mc1}, {J2, Mc2} and according to one advantageous embodiment of the disclosure, the method 20 may also comprise a count 26 for counting the number N of sets of training data {J1, Mc1}, {J2, Mc2}.

In this case, the method 20 then comprises a comparison 27 between the number N and a predetermined threshold value S. Furthermore, the sets of training data {J1, Mc1}, {J2, Mc2} may be used 28 when this number N is greater than or equal to the predetermined threshold value S.

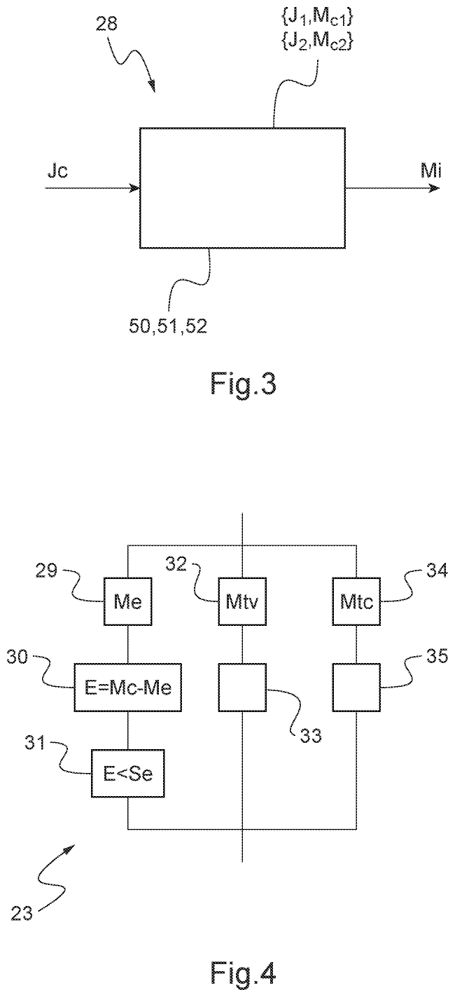

While the count 26 and comparison 27 steps are optional, the method 20 nevertheless comprises using 28 the sets of training data {J1, Mc1}, {J2, Mc2} to program the machine learning artificial intelligence model or models 50, 51, 52 as shown in FIG. 3.

Such machine learning artificial intelligence models 50, 51, 52 are further configured to estimate, at any time, using the sets of training data, an estimated instantaneous weight Mi of the aircraft 1 or another aircraft of the same type, based on a current set of flight data Jc.

Indeed, the sets of training data can be used to define calculation formulae or rules making it possible to calculate, for each predetermined flight phase, an estimated instantaneous weight Mi of the aircraft 1 directly as a function of a current set of flight data Jc.

Furthermore, said at least one machine learning artificial intelligence model 50, 51, 52 may comprise a first model 51 and a second model 52 separate from the first model 51. In this case, the first model 51 may be associated with a first predetermined flight phase of said at least one predetermined flight phase and the second model 52 may be associated with a second predetermined flight phase of said at least one predetermined flight phase. The first predetermined flight phase is separate from the second predetermined flight phase.

A particular machine learning artificial intelligence model 50, 51, 52 may therefore be associated with each predetermined flight phase. Each machine learning artificial intelligence model 50, 51, 52 may advantageously be chosen from the group comprising decision tree algorithms, random forest algorithms, support vector machine algorithms, adaptive boosting algorithms, back-propagation algorithms, gradient boosting algorithms, neural network algorithms, and deep neural network algorithms.

Moreover, the predetermined flight phase or phases may be chosen as a function of a required accuracy of the machine learning artificial intelligence model or models 50, 51, 52 for estimating, at any time, said estimated instantaneous weight Mi of said aircraft 1, or an aircraft of the same type, based on a current set of flight data Jc.

The predetermined flight phase or phases may also be chosen as a function of a required dispersion of the machine learning artificial intelligence model or models 50, 51, 52 for estimating, at any time, said estimated instantaneous weight Mi of said aircraft 1, or an aircraft of the same type, based on a current set of flight data Jc.

Furthermore, the predetermined flight phase or phases may also be chosen as a function of a required diversity of the plurality of flights carried out by the user of the aircraft 1, or an aircraft of the same type.

Moreover, as shown in FIG. 4, carrying out 23 at least one predetermined consistency test may therefore comprise several tests implemented separately from each other. The tests are then carried out 23 if at least one of the tests is validated.

Therefore, according to one test example, the reference weight Mref may be defined depending on an estimated weight Me of the aircraft 1 based on measurements from several sensors 4.

This test comprises estimating 29 the estimated weight Me, calculating 30 a difference E between the calculated weight Mc and the estimated weight Me, then checking 31 that the difference E is less than a difference threshold value Se.

According to another test, the reference weight Mref may be defined depending on a checked theoretical weight Mtv of the aircraft 1. The test then comprises checking 32 the checked theoretical weight Mtv, then checking 33 a parameterization of the checked theoretical weight Mtv.

According to another test, the reference weight Mref may also be defined depending on a calculated theoretical weight Mtc of the aircraft 1, said calculated theoretical weight Mtc being obtained by a calculation 34 using the weight calculation controller or controllers 5′, 15′ based on at least one piece of information parameterized with the human-machine interface 7 of the aircraft 1 by the user prior to this consistency test. This test then comprises checking 35 that the information has been parameterized.

Naturally, the present disclosure is subject to numerous variations as regards its implementation. Although several embodiments are described above, it should readily be understood that it is not conceivable to identify exhaustively all the possible embodiments. It is naturally possible to envisage replacing any of the means described by equivalent means without going beyond the ambit of the present disclosure.

What is claimed is:

1. A method for training at least one machine learning artificial intelligence model, the at least one machine learning artificial intelligence model being configured to be stored in a memory equipping an aircraft or a ground station, and developed in order to be implemented during at least one predetermined flight phase of at least one aircraft of the same type,
the method comprising carrying out a plurality of flights, for at least one of the plurality of flights, the method comprises acquiring, during flight, at least one set of flight data acquired with several sensing devices at the same point in time t,
wherein, for the plurality of flights, the method comprises the following steps:
carrying out at least one predetermined consistency test with at least one consistency controller, the at least one consistency test enabling to check that a reliable reference weight is calculated or capable of being calculated;
calculating, with at least one weight calculation controller, at least one calculated weight of the aircraft as a function of at least one weight chosen from the group comprising a current boarded fuel weight, a consumed fuel weight, a previously measured weight of the aircraft, an empty weight of the aircraft, a payload previously input by a user, a weight measured by a piece of connected equipment, and the reference weight; and
if the at least one consistency test is validated, storing the at least one set of flight data and the weight(s) calculated at the point in time t, each stored set of flight data associated with a calculated weight forming a set of training data for the at least one machine learning artificial intelligence model, and
wherein the method comprises using the sets of training data to program the at least one machine learning artificial intelligence model, the at least one machine learning artificial intelligence model being configured to estimate, at any time, an estimated instantaneous weight of the aircraft, or another aircraft of the same type, based on a current set of flight data.

2. The method according to claim 1,
wherein the reference weight is defined as a function of an estimated weight of the aircraft based on measurements from several sensors, each sensor being arranged on each landing gear of the aircraft, the at least one consistency test comprising calculating a difference between the calculated weight and the estimated weight and then checking that the difference is less than a difference threshold value.

3. The method according to claim 1,
wherein the reference weight is defined as a function of a checked theoretical weight of the aircraft, the at least one consistency test comprising checking the parameterization of the checked theoretical weight.

4. The method according to claim 1,
wherein the reference weight is defined as a function of a calculated theoretical weight of the aircraft, the calculated theoretical weight being obtained by the at least one weight calculation controller based on at least one piece of information parameterized with a human-machine interface of the aircraft by the user prior to the at least one consistency test, the at least one consistency test comprising checking hat the at least one piece of information has been parameterized.

5. The method according to claim 1,
wherein the flight data has data relating to at least two flight parameters chosen from the group comprising a speed of the aircraft in relation to the air, a vertical speed of the aircraft in relation to the ground, a longitudinal speed of the aircraft in relation to the ground, a lateral speed of the aircraft in relation to the ground, a vertical acceleration of the aircraft in relation to the ground, a flow of fuel supplying an engine of the aircraft, a rotational speed of a rotor equipping the aircraft, a wind direction, a wind speed, a quantity of fuel on board the aircraft, a yaw trajectory of the aircraft, the attitude of the aircraft, an air density, an air temperature, an altitude of the aircraft an angle of attack of a wing of the aircraft, a power consumed by at least one engine of the aircraft, positions of flight controls and positions of blades of a rotor and/or of a propeller.

6. The method according to claim 1,
wherein, prior to the use of the sets of training data, the method comprises a count for counting the number N of the sets of training data and a comparison between the number N and a predetermined threshold value S.

7. The method according to claim 6,
wherein the use of the sets of training data is implemented when the number N is greater than or equal to the predetermined threshold value S.

8. The method according to claim 1,
wherein the at least one machine learning artificial intelligence model comprises a first model and a second model different from the first model, the first model being associated with a first predetermined flight phase from the at least one predetermined flight phase and the second model being associated with a second predetermined flight phase from the at least one predetermined flight phase, the first predetermined flight phase being different from the second predetermined flight phase.

9. The method according to claim 1,
wherein the at least one predetermined flight phase is chosen as a function of a required accuracy of the at least one machine learning artificial intelligence model for estimating, at any time, the estimated instantaneous weight of the aircraft, or an aircraft of the same type, based on a current set of flight data.

10. The method according to claim 1,
wherein the at least one predetermined flight phase is chosen as a function of a required dispersion of the at least one machine learning artificial intelligence model for estimating, at any time, the estimated instantaneous weight of the aircraft, or an aircraft of the same type, based on a current set of flight data.

11. The method according to claim 1,
wherein the at least one predetermined flight phase is chosen as a function of a diversity of the plurality of flights performed by the user of the aircraft, or an aircraft of the same type.

12. The method according to claim 1,
wherein the at least one machine learning artificial intelligence model is chosen from the group comprising decision tree algorithms, random forest algorithms, support vector machine algorithms, adaptive boosting algorithms, back-propagation algorithms, gradient boosting algorithms, neural network algorithms, and deep neural network algorithms.
